(19) United States
(12) Patent Application Publication
(10) Pub. No.: US 2012/0169962 A1
(43) Pub. Date: Jul. 5, 2012

(54) OPTICAL SENSOR AND DISPLAY DEVICE

(75) Inventors: Ryuzo Yuki, Osaka-shi (JP); Naru Usukura, Osaka-shi (JP); Hiromi Katoh, Osaka-shi (JP); Tadashi Nemoto, Osaka-shi (JP); Hiroaki Shigeta, Osaka-shi (JP); Yuichi Kanbayashi, Osaka-shi (JP)

(73) Assignee: SHARP KABUSHIKI KAISHA, Osaka (JP)

(21) Appl. No.: 13/395,388

(22) PCT Filed: Aug. 19, 2010
(86) PCT No.: PCT/JP2010/064015

§ 371 Date: Mar. 9, 2012

(30) Foreign Application Priority Data
Sep. 9, 2009 (JP) 2009-208476

(51) Int. Cl. G02F 1/13357; H01J 9/26; G02F 1/1335

(52) U.S. Cl. 349/61; 349/106; 445/25

(57) ABSTRACT

In a liquid crystal display device, noise light to a photodetecting element is reduced, whereby an improved S/N ratio is achieved. The liquid crystal display device includes: a first substrate (100) on which a pixel circuit is provided; a second substrate (101) arranged so as to face the first substrate (100) with a liquid crystal layer (30) being interposed therebetween; a photodetecting element (17) provided on the first substrate (100); and a detection light filter (18) that is provided between the photodetecting element (17) and the liquid crystal layer (30) and that cuts off light in a band outside a signal light band that is a band of light to be detected by the photodetecting element (17).

### REFERENCE TO RELATED APPLICATIONS

This application is the national stage under 35 USC 371 of International Application No. PCT/JP2010/064015, filed Aug. 19, 2010, which claims priority from Japanese Patent Application No. 2009-208476, filed Sep. 9, 2009, the entire contents of which are incorporated herein by reference.

### FIELD OF THE INVENTION

The present invention relates to an optical sensor having a photodetecting element such as a photodiode or a phototransistor, and relates to a display device equipped with the optical sensor.

### BACKGROUND OF THE INVENTION

Conventionally, an optical-sensor-equipped display device has been proposed that includes a photodetecting element, for example, a photodiode, in each pixel so as to be capable of detecting brightness of external light and capturing an image of an object that approaches a display thereof. Known as a configuration of such an optical-sensor-equipped display device is, for example, a configuration in which light is emitted from a backlight thereof to a display thereof and light reflected by an object to be detected such as a finger touching or approaching the display is detected by an optical sensor. As such a configuration, for example, a configuration of a sensor-equipped display having a backlight that includes a light source that emits light in a non-visible light range and a light source that emits light in a visible light range has been proposed (see, for example, JP2008-262204A). In this sensor-equipped display device, light in the visible light range is emitted as display light from a display surface, while light in the non-visible light range that is, after emitted from the display surface, reflected by an object to be detected is received by a light-receiving element. With this configuration, influences to the optical sensor, such as influences of a display state, influences of ambient situations, etc., can be reduced.

### SUMMARY OF INVENTION

However, in the conventional sensor-equipped display device, a selective transmission filter that selectively transmits light in the non-visible light range is provided on a CF substrate, and a light receiving cell (sensor) is provided on a TFT substrate. Therefore, for example, in a step of laminating the CF substrate and the TFT substrate, the sensor and the selective transmission filter tend to be misaligned due to a positioning error. Through an interstice occurring due to this error, noise light such as external light is incident on the sensor. Besides, since a liquid crystal layer and the like are present between the sensor and the selective transmission filter, internal reflection light in the liquid crystal layer becomes light of a noise component, and is incident on the sensor. Such noise light causes an S/N ratio to decrease.

In light of this, it is an object of the present invention to provide an optical-sensor-equipped liquid crystal display device that is capable of reducing noise light incident on a photodetecting element and improving an S/N ratio.

A liquid crystal display device according to one embodiment of the present invention includes: a first substrate on which a pixel circuit is provided; a second substrate arranged so as to face the first substrate with a liquid crystal layer being interposed therebetween; a photodetecting element provided on the first substrate; and a detection light filter that is provided between the photodetecting element and the liquid crystal layer and that cuts off light in a band outside a signal light band that is a band of light to be detected by the photodetecting element.

The present invention makes it possible to reduce noise light incident on a photodetecting element and to improve the S/N ratio.

### BRIEF DESCRIPTION OF DRAWINGS

FIG. 1 is a block diagram showing a schematic configuration of a TFT substrate of a liquid crystal display device according to Embodiment 1.

FIG. 2 is an equivalent circuit diagram showing an arrangement of a pixel and an optical sensor in a pixel region of the TFT substrate.

FIG. 3 is an exemplary timing chart of the liquid crystal display device.

FIG. 4A is a top view showing an area for one pixel in a pixel region 1 of the liquid crystal display device according to Embodiment 1.

FIG. 4B is a cross-sectional view taken along a line x2-x′2 in FIG. 4A.

FIG. 4C is a cross-sectional view taken along a line y2-y′2 in FIG. 4A.

FIG. 5A is an enlarged top perspective view showing an optical sensor including a photodiode 17.

FIG. 5B is a cross-sectional view taken along a line A-A′ in FIG. 5A.

FIG. 6 is a cross-sectional view showing an exemplary configuration of a liquid crystal display device in which an infrared light transmission filter is provided in a counter substrate.

FIG. 7 explains an exemplary ray in the liquid crystal display device according to Embodiment 1.

FIG. 8A is a graph showing exemplary wavelength characteristics of sensitivities of an optical sensor.

FIG. 8B is a graph showing exemplary wavelength characteristics of light emitted from an infrared LED.

FIG. 8C is a graph showing exemplary filter characteristics of an infrared light transmission filter.

FIG. 8D is a graph showing exemplary wavelength characteristics of sunlight.

FIG. 9 shows a first exemplary configuration of a backlight.

FIG. 10 shows a second exemplary configuration of a backlight.

FIG. 11 shows a third exemplary configuration of a backlight.

FIG. 12 shows a fourth exemplary configuration of a backlight.

FIG. 13 shows a fifth exemplary configuration of a backlight.

FIG. 14 is a cross-sectional view of the backlight shown in FIG. 13.

FIG. 15 is a cross-sectional view of a liquid crystal display device according to Embodiment 2.

FIG. 16 is a graph showing exemplary transmission characteristics of an infrared light transmission filter and an unwanted infrared light cut filter.

FIG. 17A is a top view showing an area for one pixel in a pixel region 1 of a liquid crystal display device according to Embodiment 3.

FIG. 17B is a cross-sectional view taken along a line x3-x′3 in FIG. 17A.

FIG. 17C is a cross-sectional view taken along a line y3-y′3 in FIG. 17A.

### DETAILED DESCRIPTION OF THE INVENTION

A liquid crystal display device according to one embodiment of the present invention includes: a first substrate on which a pixel circuit is provided; a second substrate arranged so as to face the first substrate with a liquid crystal layer being interposed therebetween; a photodetecting element provided on the first substrate; and a detection light filter that is provided between the photodetecting element and the liquid crystal layer and that cuts off light in a band outside a signal light band that is a band of light to be detected by the photodetecting element (first configuration).

By providing the detection light filter for cutting off light in a band outside the signal light band between the photodetecting element and the liquid crystal layer as described above, the distance between the photodetecting element and the detection light filter can be shortened. This configuration reduces light as a noise incident on the photodetecting element, thereby improving the S/N ratio.

The above-described first configuration preferably further includes: a backlight provided on a side of the first substrate opposite to the liquid crystal layer, the backlight including a light emitter that emits light in the signal light band; and a shielding part that is provided between the photodetecting element and the backlight and that prevents light of the backlight from directly reaching the photodetecting element (second configuration). With this, light emitted by the light emitter of the backlight is prevented from directly reaching the photodetecting element. Therefore, this makes it possible that only reflected light is detected by the photodetecting element.

The first configuration described above preferably further includes: a backlight that is provided on a side of the first substrate opposite to the liquid crystal layer, and that includes a light emitter that emits light in the signal light band, and another light emitter that emits light that is in a band different from the signal light band and that is used for display; and a shielding part that is provided between the photodetecting element and the backlight and that prevents light of the backlight from directly reaching the photodetecting element (third configuration). In this configuration, the photodetecting element by no means detects light emitted for display, among light emitted by the backlight. Therefore, the light emitted for display is prevented from influencing the photodetecting element. Moreover, with the shielding part, it is possible to prevent light of the backlight from directly reaching the photodetecting element. Therefore, only reflected light, among light in the signal light band emitted by the backlight, can be detected by the photodetecting element.

In any one of the first to third configurations, a color filter may be provided on the first substrate (fourth configuration).

In any one of the firs to fourth configurations, the signal light band preferably falls in a band of infrared rays (fifth configuration).

A method for manufacturing a liquid crystal display device, according to one embodiment of the present invention, includes the steps of forming a pixel circuit and a photodetecting element on a first substrate; forming a detection light filter on the first substrate so that the detection light filter covers the photodetecting element, the detection light filter cutting off light in a band outside a signal light band that is a band of light to be detected by the photodetecting element; and laminating the first substrate on which the detection light filter is formed and a second substrate so that the first substrate and the second substrate face each other, and injecting liquid crystal into between the first substrate and the second substrate (sixth method).

According to the above-described manufacturing method, the detection light filter is formed on the first substrate on which the pixel circuit and the photodetecting element are formed. Therefore, the light detection filter can be formed, without the steps being made complex. Further, in the step of laminating the first and second substrates, there is no need to perform position adjustment of the light detection filter and the photodetecting element. Therefore, the liquid crystal display device can be manufactured efficiently.

In the sixth method, in the step of forming the detection light filter on the first substrate, a color filter may be formed also on the first substrate (seventh method). By forming the color filter also in the step of forming the detection light filter in this way, the liquid crystal display device can be manufactured efficiently.

Hereinafter, specific embodiments are explained with reference to drawings. It should be noted that the following description of the embodiments explains exemplary configurations in the case where a display device according to an embodiment of the present invention is a liquid crystal display device. It should be noted that a display device according to an embodiment of the present invention, as having optical sensors, is assumed to be used as a touch-panel-equipped display device that detects an object approaching its screen and carries out an input operation, a display device for two-way communication having a display function and an image pickup function, etc.

Further, the drawings referred to hereinafter show, in a simplified manner, only principal members needed for explanation of the present invention among constituent members of the embodiment of the present invention, for convenience of explanation. Therefore, a display device according to an embodiment of the present invention may include arbitrary constituent members that are not shown in the drawings that the present specification refers to. Further, the dimensions of the members shown in the drawings do not faithfully reflect actual dimensions of constituent members, dimensional ratios of the members, etc.

### Embodiment 1

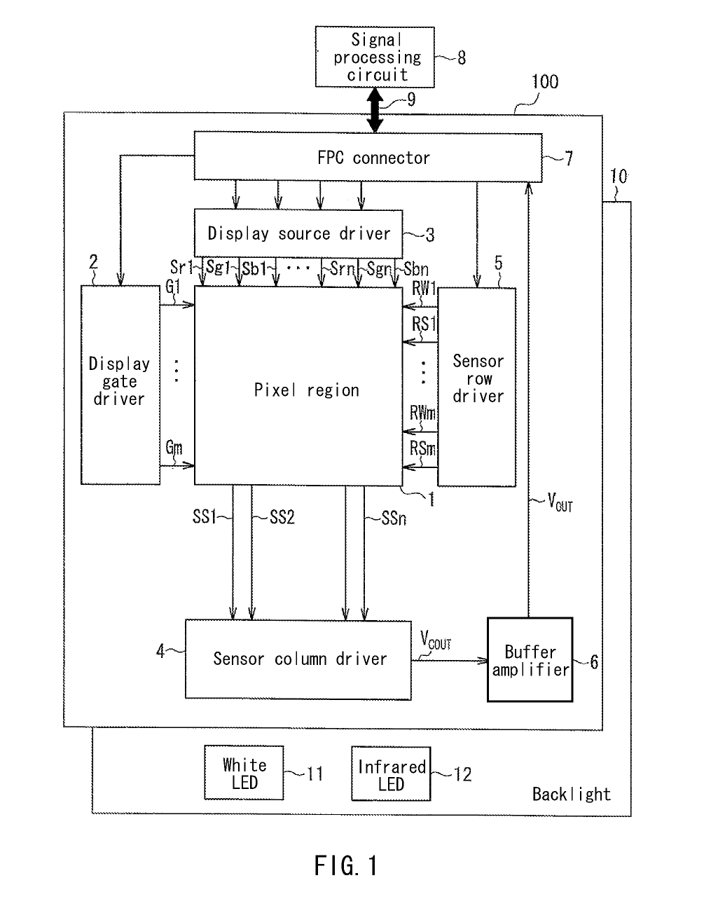

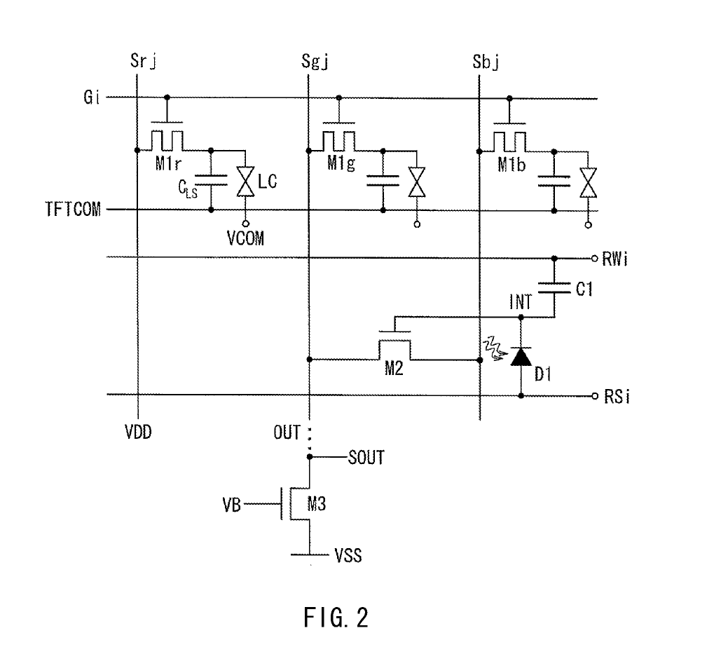

First, a configuration of a TFT substrate provided in a liquid crystal display device according to Embodiment 1 is explained, with reference to FIGS. 1 and 2.

### Configuration of TFT Substrate

FIG. 1 is a block diagram showing a schematic configuration of a TFT substrate 100 provided in a liquid crystal display device according to Embodiment 1. As shown in FIG. 1, the TFT substrate 100 includes, on a glass substrate, at least a pixel region 1, a display gate driver 2, a display source driver 3, a sensor column driver 4, a sensor row driver 5, a buffer amplifier 6, and an FPC connector 7. Further, a signal processing circuit 8 for processing image signals captured by optical sensors (described later) in the pixel region 1 is connected to the TFT substrate 100 via the aforementioned FPC connector 7 and an FPC (flexible printed circuit) 9.

The pixel region 1 is a region where pixel circuits including a plurality of pixels for displaying images are formed. In the present embodiment, in each pixel in the pixel circuit, there is provided an optical sensor for capturing images. The pixel circuits are connected to the display gate driver 2 by m gate lines G1 to Gm, and are connected to the display source driver 3 by 3 n source lines Sr1 to Srn, Sg1 to Sgn, and Sb1 to Sbn. The pixel circuits are connected to the sensor row driver 5 by m reset signal lines RS1 to RSm and m readout signal lines RW1 to RWm, and are connected to the sensor column driver 4 by n sensor output lines SS1 to SSn.

It should be noted that the above-described constituent members of the TFT substrate 100 may be formed monolithically on the glass substrate through semiconductor processing. Alternatively, the configuration may be as follows: the amplifiers and drivers among the above-described constituent members may be mounted on the glass substrate by, for example, COG (chip on glass) techniques. Further alternatively, at least a part of the aforementioned constituent members on the TFT substrate 100 in FIG. 1 may be mounted on the FPC 9. The TFT substrate 100 is laminated with a counter substrate (not shown) having a counter electrode formed over an entire surface thereof. A liquid crystal material is sealed in a space formed between the TFT substrate 100 and the counter substrate.

On a back side of the TFT substrate 100, a backlight 10 is provided. The backlight 10 includes a white light LED (light emitting diode) 11 that emits white light (visible light) and an infrared LED 12 that emits infrared light (infrared ray). In the present embodiment, the infrared LED 12 is used as a light emitter that emits light in a signal light band of an optical sensor, which is an example. The white light LED 11 is used as another light emitter that emits light for display. It should be noted that the light emitters of the backlight are not limited to the above-described examples. A combination of a red LED, a green LED, and a blue LED, for example, may be used as a visible light emitter. Alternatively, a cold cathode fluorescent lamp (CCFL) may be used in place of the LED.

### Configuration of Display Circuit

FIG. 2 is an equivalent circuit diagram showing an arrangement of pixels and optical sensors in the pixel region 1 of the TFT substrate 100. In the example shown in FIG. 2, one pixel is formed with three primary color dots of R (red), G (green), and B (blue). In one pixel composed of these three color dots, there is provided one optical sensor. The pixel region 1 includes the pixels arrayed in a matrix of m rows×n columns, and the optical sensors arrayed likewise in a matrix of m rows×n columns. It should be noted that the number of the color dots is m×3 n, since one pixel is composed of three dots, as described above.

As shown in FIG. 2, the pixel region 1 has gate lines G and source lines Sr, Sg, and Sb arrayed in matrix as lines for pixels. The gate lines G are connected to the display gate driver 2. The source lines SL are connected to the display source driver 3. It should be noted that m rows of the gate lines G are provided in the pixel region 1. Hereinafter, when an individual gate line G needs to be described distinctly, it is denoted by Gi (i=1 to M). On the other hand, three source lines Sr, Sg, and Sb are provided per one pixel so as to supply image data to three color dots in the pixel, as described above. When an individual source line Sr, Sg, or Sb needs to be described distinctly, it is denoted by Srj, Sgj, or Sbj (j=1 to N).

At each of intersections of the gate lines G and the source lines Sr, Sg, and Sb, a thin-film transistor (TFT) M1 is provided as a switching element for a pixel. It should be noted that in FIG. 2, the thin film transistors M1 provided for color dots of red, green, and blue are denoted by M1r, M1g, and M1b, respectively. A gate electrode of the thin-film transistor M1 is connected to the gate line G, a source electrode thereof is connected to the source line, and a drain electrode thereof is connected to a pixel electrode, which is not shown. Thus, a liquid crystal capacitor C_{LC} is formed between the drain electrode of the thin film transistor M1 and the counter electrode (VCOM), as shown in FIG. 2. Further, an auxiliary capacitor C_{LS} is formed between the drain electrode and a TFT COM.

In FIG. 2, for a color dot driven by a thin-film transistor M1g connected to an intersection of one gate line Gi and one source line Srj, a red color filter is provided so as to correspond to this color dot. This color dot is supplied with image data of red color from the display source driver 3 via the source Srj, thereby functioning as a red color dot.

Further, for a color dot driven by a thin-film transistor M1g connected to an intersection of the gate line Gi and the source line Sgj, a green color filter is provided so as to correspond to this color dot. This color dot is supplied with image data of green color from the display source driver 3 via the source line Sgj, thereby functioning as a green color dot.

Still further, for a color dot driven by a thin-film transistor M lb connected to an intersection of the gate line Gi and the source line Sbj, a blue color filter is provided so as to correspond to this color dot. This color dot is supplied with image data of blue color from the display source driver 3 via the source line Sbj, thereby functioning as a blue color dot.

It should be noted that in the example shown in FIG. 2, optical sensors are provided so that one optical sensor corresponds to one pixel (three color dots) in the pixel region 1. The ratio between the pixels and the optical sensors provided, however, is not limited to this example, but is arbitrary. For example, one optical sensor may be provided per one color dot, or one optical sensor may be provided per a plurality of pixels.

### Configuration of Optical Sensor Circuit

The optical sensor includes a photodiode D1 as an exemplary photodetecting element, and a transistor M2 as an exemplary switching element, as shown in FIG. 2. To an anode of the photodiode D1, a reset signal line RS for supplying a reset signal is connected. To a cathode of the photodiode D1, a gate of the transistor M2 is connected. A node on the line that connects the photodiode D1 and the gate of the transistor M2 with each other is referred to as an “accumulation node” denoted by “INT” as shown in FIG. 2. To the accumulation node INT, one electrode of the capacitor C1 is connected also. The other electrode of the capacitor C1 is connected to a readout signal line RW for supplying a readout signal. A drain of the transistor M2 is connected to a line VDD, and a source thereof is connected to a line OUT. The line VDD is a line for supplying a constant voltage VDD to the optical sensor. The line OUT is an exemplary output line for outputting an output signal of the optical sensor.

In the circuit shown in FIG. 2, when the reset signal is supplied from the reset signal line RS, the potential V_{INT} of the accumulation node INT is initialized. After the reset signal is supplied, the photodiode D1 is reverse-biased. When a readout signal is supplied from the readout signal line RW to the accumulation node INT via the capacitor C1, the potential V_{INT} of the accumulation node INT is boosted up, whereby the transistor M2 becomes conductive. Thus, an output signal according to the potential V_{INT} of the accumulation node INT is output to the line OUT. Here, during a period from when the supply of the reset signal ends to when the supply of the readout signal starts (integration period), an electric current according to an amount of received light flows through the photodiode D1, and charges according to this electric current are accumulated in the capacitor C1. Therefore, when the readout signal is supplied, the potential V_{INT} of the accumulation node INT varies with an electric current flowing through the photodiode D1. Since an output signal according to the potential V_{INT} of the accumulation node INT is output to the line OUT, the output signal reflects an amount of light received by the photodiode D1. It should be noted that the configuration of the sensor circuit is not limited to the above-described example.

In the example shown in FIG. 2, the source line Sr functions also as the line VDD for supplying the constant voltage V_{DD} form the sensor column driver 4 to the optical sensor. The source line Sg functions also as the line OUT for sensor output. Further, the reset signal line RS and the readout signal line RW are connected to the sensor row driver 5. The above-mentioned reset signal line RS and readout signal line RW are provided per each row. Therefore, in the following description, when the lines should be distinguished, they are denoted by RSi and RWi (i=1 to M).

The sensor row driver 5 selects the reset signal lines RSi and the readout signal lines RWi in combination shown in FIG. 2 sequentially at predetermined time intervals t_{row}. With this, the rows of the optical sensors from which signal charges are to be read out in the pixel region 1 are selected sequentially.

It should be noted that, as shown in FIG. 2, a drain of a transistor M3 is connected to an end of the line OUT. The transistor M3 may be, for example, an insulated gate field effect transistor. To the drain of the transistor M3, the output line SOUT is connected. Therefore, a potential V_{SOUT} of the drain of the transistor M3 is output as an output signal from the optical sensor, to the sensor column driver 4. A source of the transistor M3 is connected to the line VSS. A gate of the transistor M3 is connected to a reference voltage source (not shown) via a reference voltage line VB.

### Exemplary Operation

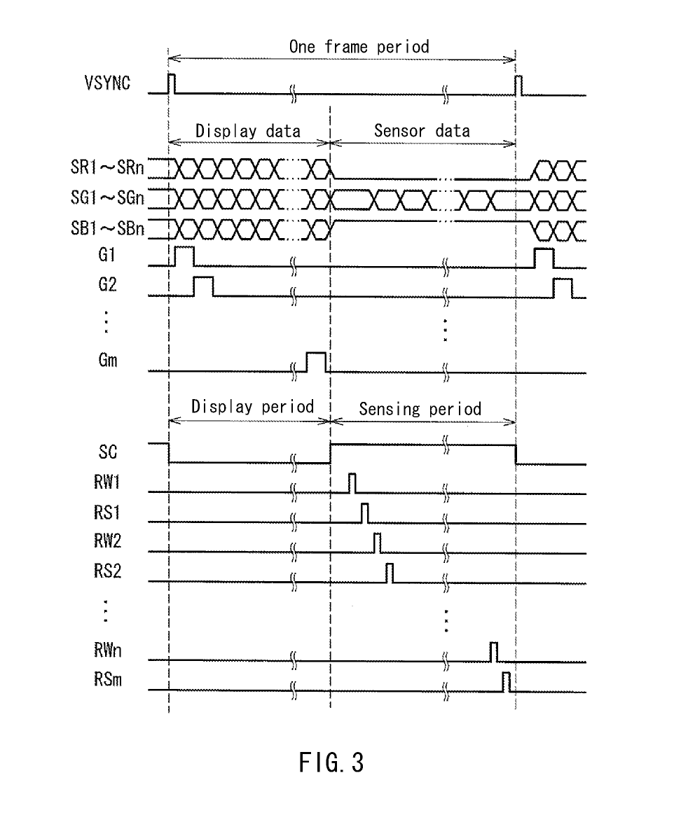

FIG. 3 shows an exemplary timing chart of the liquid crystal display device. In the example shown in FIG. 3, a vertical synchronization signal VSYNC assumes a high level per one frame period. One frame period is divided into a display period and a sensing period. A signal SC is a signal for distinguishing the display period and the sensing period, and it assumes a low level during the display period, while assuming a high level during the sensing period.

During the display period, signals of display data are supplied from the display source driver 3 to the source lines Sr, Sg, and Sb. During the display period, the display gate driver 2 sequentially causes voltages of the gate lines G1 to Gm to be at a high level. While the voltage of the gate line Gi is at a high level, voltages corresponding to respective gray scale levels (pixel values) at the 3 n color dots connected to the gate line Gi are applied to the source lines Sr1 to Srn, Sg1 to Sgn, and Sb1 to Sbn.

During the sensing period, the constant voltage V_{DD} is applied to the source lines Sg1 to Sgn. During the sensing period, the sensor row driver 5 sequentially selects rows of the reset signal lines RSi and the readout signal lines RWi sequentially at predetermined time intervals t_{row}. To the reset signal line RSi and the readout signal line RWi of the selected row, the reset signal and the readout signal are applied, respectively. To the source lines Sb1 to Sbn, voltages according to amounts of light detected by n optical sensors connected to the readout signal RWi of the selected row are output, respectively.

### Exemplary Configuration of Liquid Crystal Display Device

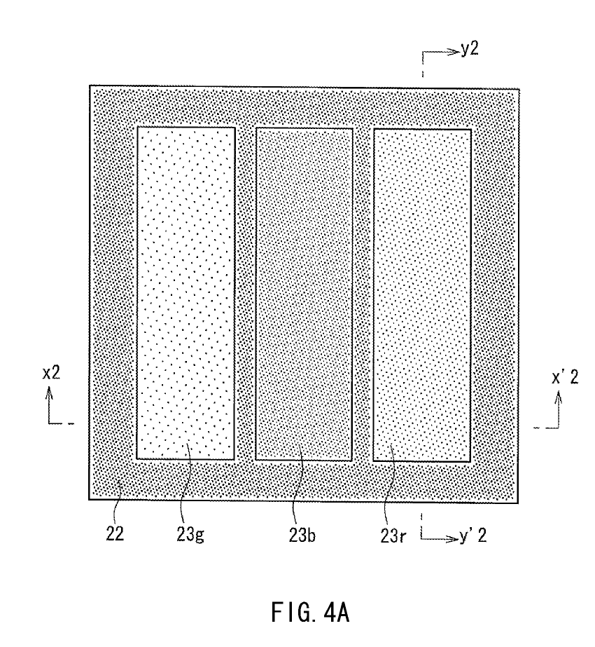

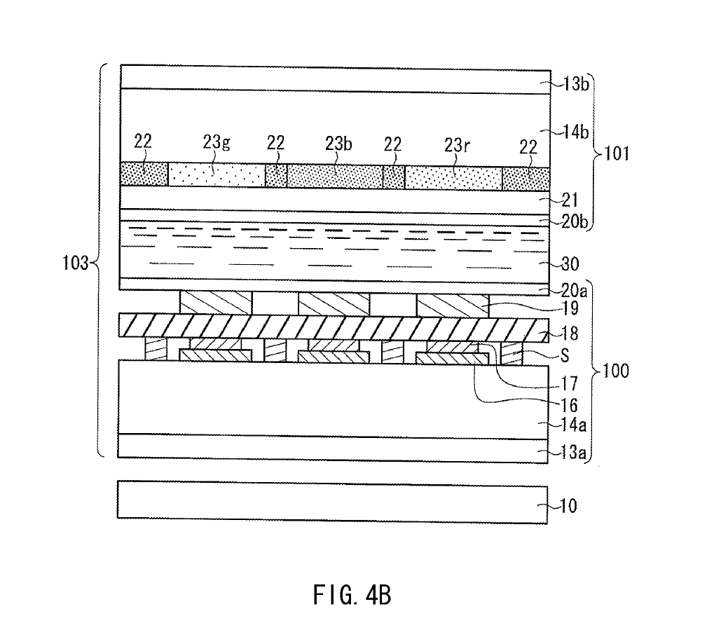

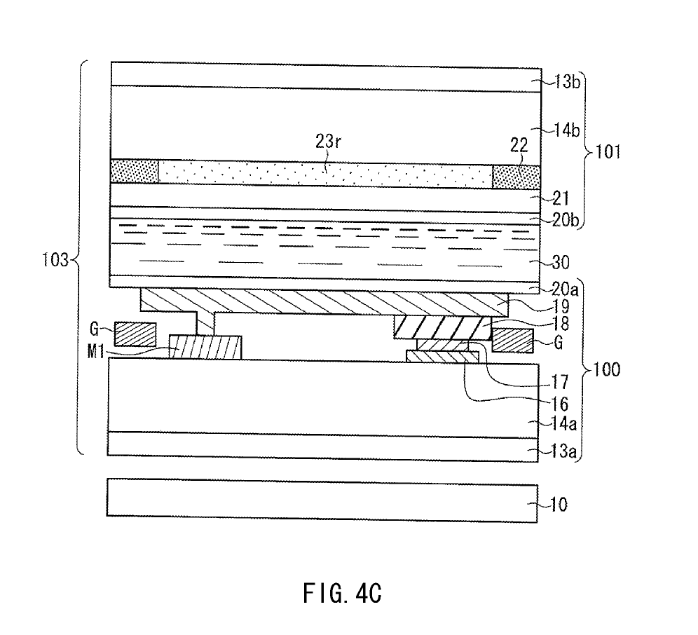

FIG. 4A is a top view showing an area of one pixel in the pixel region of the liquid crystal display device according to the present embodiment. FIG. 4B is a cross-sectional view taken along a line x2-x′2 in FIG. 4A, and FIG. 4C is a cross-sectional view taken along a line y2-y′2 in FIG. 4A. As shown in FIGS. 4B and 4C, the liquid crystal display device according to the present embodiment includes a liquid crystal panel 103 and the backlight 10. The liquid crystal panel 103 has the following configuration: a first substrate (TFT substrate 100) on which the pixel circuits are provided, and a second substrate (counter substrate 101) on which color filters 23g, 23b, and 23r are provided, are arranged so as to face each other, with the liquid crystal layer 30 being interposed therebetween. In the present embodiment, a face of the liquid crystal panel 103 on the counter substrate 101 side is a front face, and a face thereof on the TFT substrate 100 side is a back face. The backlight 10 is provided on the back face of the liquid crystal panel 103. Light polarization plates 13a and 13b are provided on the back face and the front face of the liquid crystal panel 103, respectively.

In the counter substrate 101, on a liquid crystal layer 30 side face of a glass substrate 14b thereof, a layer having color filters 23g, 23b, and 23r, and a black matrix 22 is formed. The counter electrode 21 and an alignment film 20b are formed so as to cover the above-described layer.

In the TFT substrate 100, a pixel circuit is formed that includes optical sensors at positions corresponding to the color dots 23g, 23b, and 23r on the glass substrate 14b. More specifically, an optical sensor is formed with a light shielding layer 16 provided on the glass substrate 14a, and a photodiode provided on the light shielding layer 16. The light shielding layer 16 is an exemplary shielding part provided so as to prevent light emitted by the backlight 10 from directly influencing operations of the photodiode 17. On the glass substrate 14a, the TFT M1, the gate line G, and the source line S, which compose the pixel circuit, are formed.

Between the photodiode 17 and the liquid crystal layer 30, an infrared light transmission filter 18 that absorbs light except for light in an infrared light range. The infrared light transmission filter 18 is formed so as to cover the optical sensors formed on the glass substrate 14a. A resin filter similar to those for the color filters 23g, 23b, and 23r may be used as the infrared light transmission filter 18. The infrared light transmission filter 18 and the color filters can be formed with a negative-type photosensitive resist obtained by dispersing a pigment or carbon in a base resin such as an acrylic resin or a polyimide resin. More specifically, the infrared light transmission filter 18 can be obtained by, for example, laminating a red color filter and a blue color filter.

On the infrared light transmission filter 18, a pixel electrode 19 is provided that is connected to the TFT M1 through a contact hole. On the pixel electrode 19, an alignment film 20a is provided.

The infrared light transmission filter 18 is an exemplary detection light filter for cutting off light in a band outside a signal light band that is a band of light to be detected by a photodetecting element (here, the photodiode 17). More specifically, by the infrared light transmission filter 18 provided so as to cover the optical sensors, the incidence of noise light on the photodiode 17 is suppressed. Since the infrared light transmission filter 18 is provided between the photodiode 17 and the liquid crystal layer 30, the effect of suppressing the incidence of noise light is enhanced, as compared with the case where the infrared light transmission filter 18 is provided on the counter substrate 101 side. Further, in the example shown in FIGS. 4A to 4C, the infrared light transmission filter 18 is formed, for example, with one film that covers three photodiodes 17 that are provided corresponding to the red, blue, and green color dots, respectively. This makes it possible to more efficiently suppress the incidence of light that becomes a noise component.

### Exemplary Configuration of Optical Sensor Part

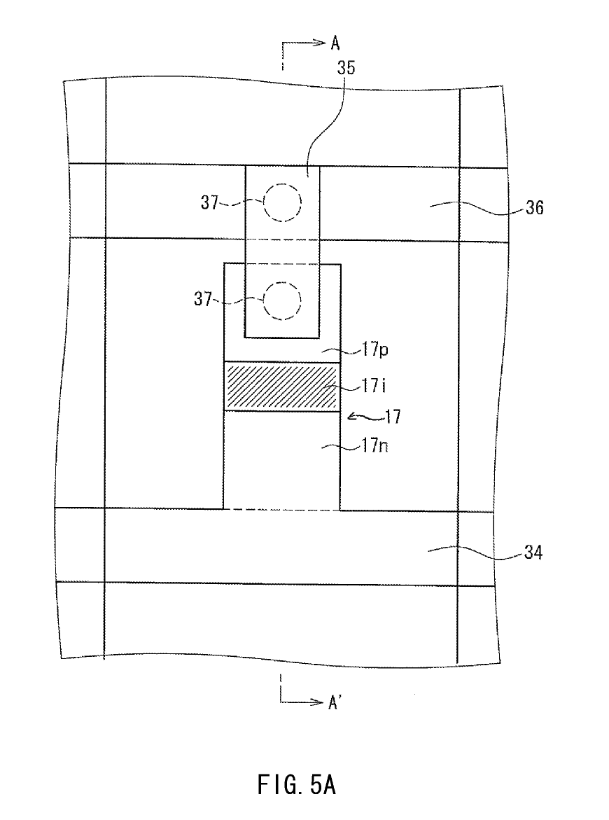

FIG. 5A is an enlarged top perspective view showing an optical sensor including a photodiode 17. FIG. 5B is a cross-sectional view taken along a line A-A′ in FIG. 5A. The photodiode 17 is formed on a base film 31 as an insulation film covering the light shielding film 16. The photodiode 17 is formed with a silicon film electrically insulated with respect to the light shielding film 16. In this silicon film, there are provided an n-type semiconductor region (n-layer) 17n, an intrinsic semiconductor region (i-layer) 17i, and a p-type semiconductor region (p-layer) 17p in this order along a plane direction.

A gate insulation film 32 is provided so as to cover the photodiode 17. On this gate insulation film 32, a line 36 is formed in the same layer as the gate electrode of the TFT. Further, an interlayer insulation film 33 is provided on the gate insulation film 32 so as to cover the line 36. On the interlayer insulation film 33, a line 35 is provided in the same layer as the source electrode of the TFT. The p-layer 17p of the photodiode 17 is connected to the line 35 on the interlayer insulation film 33 via a contact hole 37. This line 35 is connected to the line 36 on the gate insulation film 32 via the contact hole 37. The n-layer 17n is connected to a line 34 in the same layer.

### Fabrication Method

Next, a method for fabricating the liquid crystal display device according to the present embodiment is explained. In the process of fabrication of the TFT substrate 100, first, the following is carried out: on a mother glass that is an exemplary substrate material, electrodes, TFTs, and photodiodes that compose pixel circuits are formed in a plurality of areas that become liquid crystal display panels, respectively.

Here, steps for fabricating the optical sensor shown in FIGS. 5A and 5B are explained. First, a metal film is formed by sputtering on the glass substrate 14a, whereby the light shielding layer 16 is formed. Next, the base film 31 of SiO₂ is formed by CVD. Next, the semiconductor layer for forming the photodiode 17 is formed by CVD, and the p-layer 17p, the n-layer 17n, the i-layer 17i, and the line 34 are formed. Next, the gate insulation film 32 is formed by CVD, and thereafter, a metal film is formed by sputtering, and the line 36 is formed in the same layer as the gate electrode of the TFT. Next, the interlayer insulation film 33 is formed by CVD, and thereafter, the contact hole 37 is formed. A metal film is formed by sputtering so as to cover the contact hole 37, whereby the line 35 in the same layer as the source electrode of the TFT is formed. Then, the infrared light transmission filter 18 is formed through application of a resist, exposure, development, and baking.

In the steps for fabricating the counter substrate 101, for example, color filters, black matrixes, counter electrodes, alignment films, etc. are formed on a transparent mother glass. As the color filters, for example, a filter layer of three colors of red, green, and blue is formed in each of respective display areas of the plurality of liquid crystal display panels.

The TFT substrate 100 and the counter substrate 101, which are thus formed, are laminated via a seal, and liquid crystal is injected between the TFT substrate 100 and the counter substrate 101, whereby the liquid crystal display panel 103 is fabricated. On a back side of the liquid crystal panel 103, the backlight 10 is attached.

### Explanation of Effects, Etc.

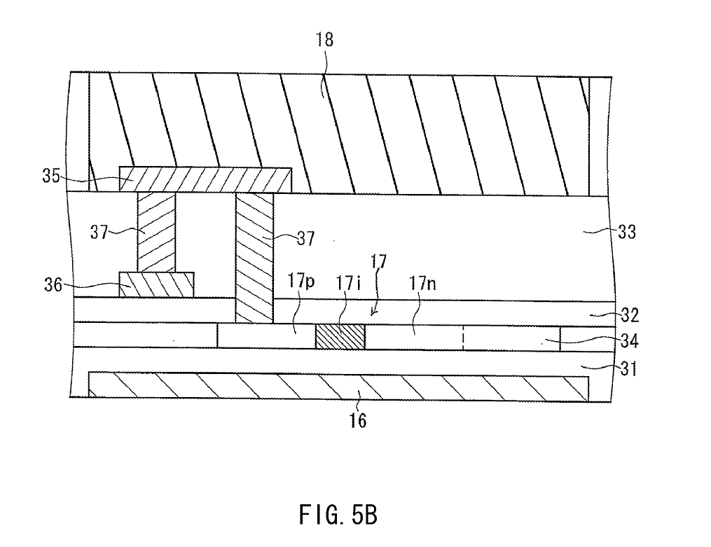

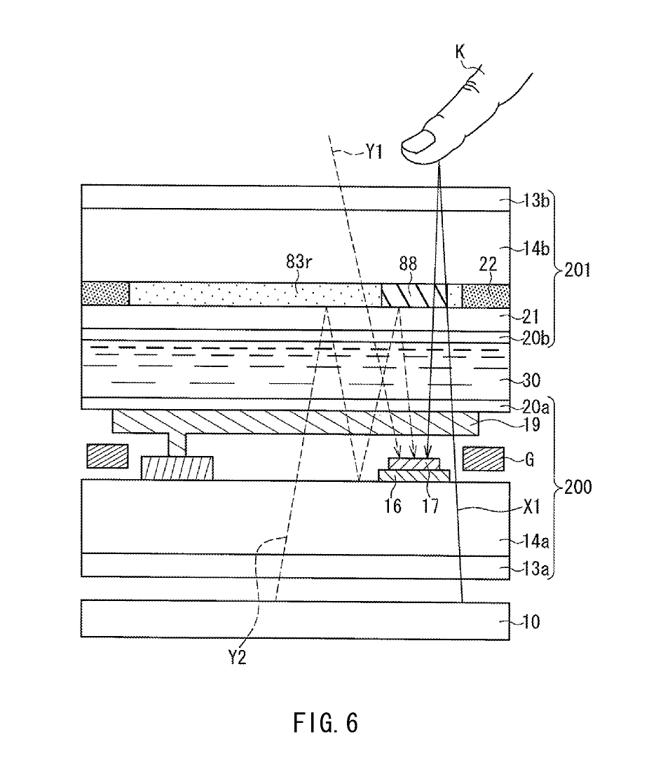

FIG. 6 is a cross-sectional view showing an exemplary configuration of a liquid crystal display device in which an infrared light transmission filter is provided in a counter substrate. In the configuration shown in FIG. 6, an infrared light transmission filter 88 is formed in the same layer as the color filter 83r in the counter substrate 201. In the configuration shown in FIG. 6, the counter substrate 201 and a TFT substrate 200 are aligned so that the infrared light transmission filter 88 is arranged at a position corresponding to the photodiode 17.

In the example shown in FIG. 6, as indicated by a solid-line arrow X1, infrared light emitted from the backlight 10 goes out of a surface of the liquid crystal panel, and is reflected by an object K to be detected. Then, the infrared light goes through the infrared light transmission filter 88, and is incident on the photodiode 17. This incident light becomes signal light for the photodiode. On the other hand, external light entering through a pixel opening where the color filter 83r is provided is incident on the photodiode 17 in some cases, for example, as indicated by a dotted-line arrow Y1 in FIG. 6. This external light becomes a noise component for the photodiode 17. If the photodiode 17 and the infrared light transmission filter 88 are displaced with each other due to an error in the positioning that occurs in the step of laminating the TFT 200 and the counter substrate 201, light that becomes a noise component increases further. Besides, since a gap such as the liquid crystal layer 30 is present between the TFT substrate 200 and the counter substrate 201, external light entering through the pixel opening or light coming from the backlight 10 is reflected inside and reaches the photodiode 17 in some cases, as indicated by a dotted-line arrow Y2 in FIG. 6. Such light also becomes a noise component for the photodiode 17.

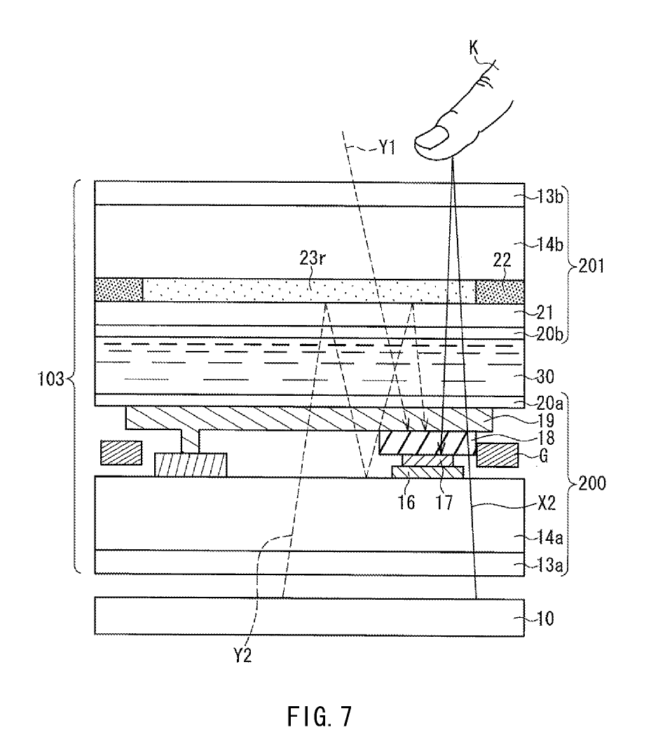

FIG. 7 explains an exemplary ray in the liquid crystal display device according to the present embodiment. Infrared light, for example, emitted from an infrared LED 12 of the backlight 10, as indicated by a solid-line arrow X2, goes out of the surface of the liquid crystal panel 103 to outside. Here, an object K to be detected, such as a finger, is positioned on the surface of the liquid crystal panel 103, or in the vicinity of the surface, the infrared light is reflected by the object K to be detected, goes through the glass substrate 14b, the liquid crystal layer 30, the infrared light transmission filter 18, etc. and becomes incident on the photodiode 17. This incident light becomes signal light for the photodiode 17 (optical sensor). In other words, only light reflected by the object K to be detected, in the infrared light contained in the backlight light, is incident on the optical sensor. Therefore, the optical sensor can detect an infrared light reflection image of the object K to be detected.

As shown in FIG. 7, the infrared light transmission filter 18 is provided between the photodiode 17 and the liquid crystal layer 30 so as to cover the photodiode 17, whereby external light (e.g., light indicated by a dotted-line arrow Y1) that becomes a noise component, or an internal reflection light (e.g., light indicated by a dotted-line arrow Y2) is cut off by the infrared light transmission filter 18. Besides, even if the infrared light transmission filter 18 and the photodiode 17 are displaced with each other in the positioning, light except for infrared light is cut off by the infrared light transmission filter 18, and therefore, it is unlikely that noise light would increase. For example, even in the case where the infrared light transmission filter 18 is displaced from a position immediately above the photodiode 17 and there is a gap between the infrared light transmission filter and the optical sensor in a planar view, the above-described configuration makes it possible to suppress a phenomenon in which external light, etc., entering through the gap becomes noise light and reaches the photodiode 17. As a result, the photodiode 17 has an improved S/N ratio. In other words, the above-described configuration makes it possible to suppress a decrease in the S/N ratio of the photodiode 17 due to an error in the positioning when the TFT substrate 100 and the counter substrate 101 are laminated with each other.

Further, in the case of the example shown in FIG. 7, the color filter does not have to be provided with an opening (optical sensor opening) where the infrared light transmission filter is to be provided, and therefore, the pixel aperture ratio (transmissivity of the liquid crystal panel) is improved. Still further, in the case of the example shown in FIG. 7, since there is not the above-described opening, light leakage from openings can be reduced, whereby the improvement of contrast of the liquid crystal panel can be achieved.

Still further, the above-described configuration makes it possible to eliminate an unnecessary gap between the infrared light transmission filter 18 and the optical sensor. This causes light that becomes a noise component for optical sensors, such as internal reflection light, to decrease, thereby improving the S/N ratio.

It should be noted that regarding the example shown in FIG. 7, a case where light that is emitted from the backlight 10 and is reflected at the object K to be detected is explained above, but the method for detecting the object K to be detected is not limited to this method. For example, in an environment in which external light contains infrared light (signal light for the optical sensor) (e.g., outdoor, or in a situation in which light from a halogen lamp is received), it may be possible to detect the object to be detected, utilizing infrared light contained in external light. In this case, if the object to be detected is located in the vicinity of the surface of the liquid crystal display panel 103, external light incident on the surface of the liquid crystal panel is blocked. In other words, an image of the object to be detected, picked up with infrared light contained in the external light, can be detected, using the optical sensor. For example, based on an amount of light received by the photodiode 17, the presence/absence of an object to be detected can be determined.

The above-described method for detecting reflected light of the backlight with the optical sensor, and the method for detecting external light, may be used in combination. For example, in the case where external light contains infrared light, a picked-up image of an object to be detected is detected with external light, in a state in which the backlight 10 is turned off, and on the other hand, in the case where external light does not contain infrared light, a reflection image of the same with infrared light of the backlight is detected, in a state in which the backlight 10 is turned on.

### Relationship Between Infrared Light Transmission Filter and Sensor

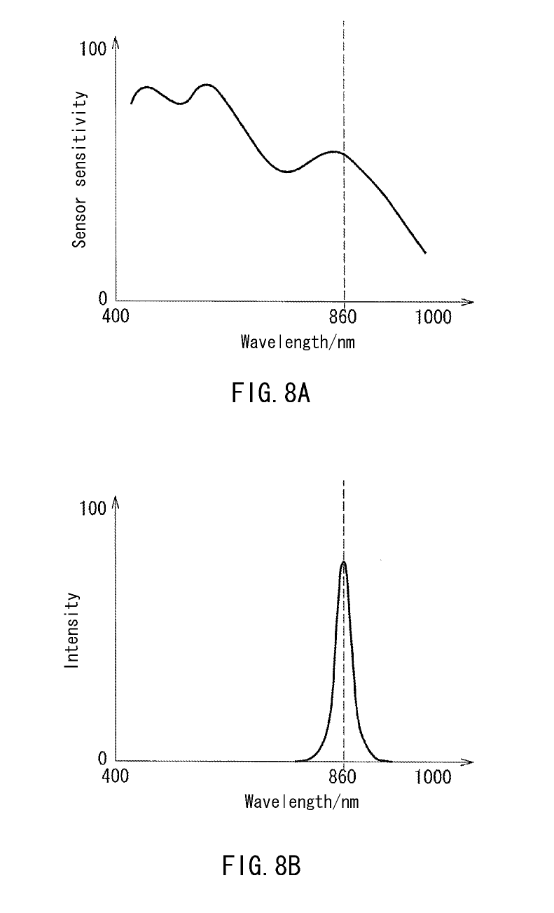

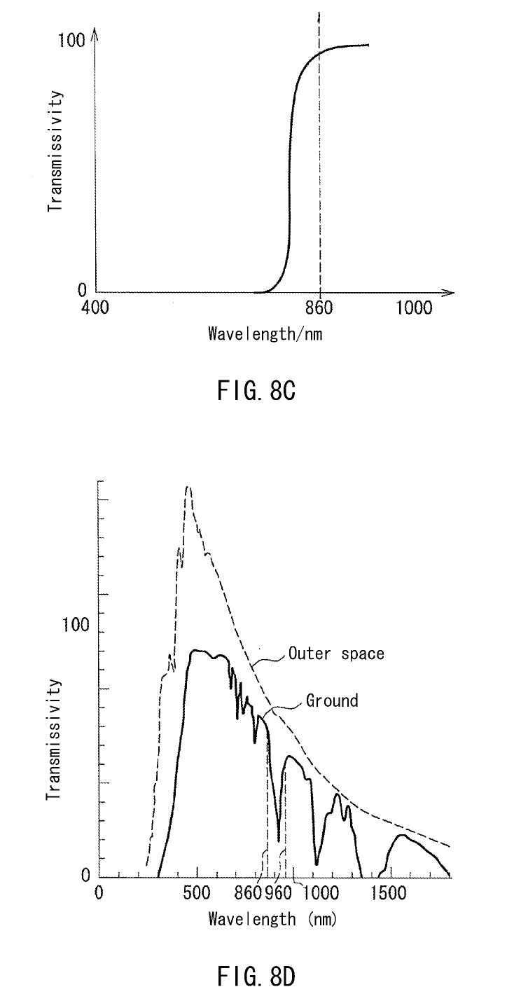

FIG. 8A is a graph showing exemplary wavelength characteristics of sensitivities of an optical sensor used in the present embodiment. The optical sensor has sensitivity throughout the whole wavelength range in this way, and therefore, light having a wavelength in a wavelength range except for the wavelength of a light source provided for the sensor (e.g., external light, sunlight, etc.) becomes a noise. Therefore, in the present embodiment, light having a wavelength in a band outside the band of the signal light detected by the optical sensor, that is, light that has a wavelength in the above described band and therefore becomes noise, is cut off by the infrared light transmission filter 18 (exemplary detection light filter). The present embodiment is explained with reference to an exemplary case where the band of the signal light detected by the optical sensor is the band of infrared light, but the signal light band is not limited to the infrared light band.

In the case where the method in which the optical sensor detects reflected light of the backlight is used, the signal light band is decided depending on the wavelength of light emitted by a light source for the optical sensor. Therefore, for example, in the case where an optical sensor having higher sensitivity with respect to wavelengths in the infrared light band than sensitivity with respect to wavelengths in the vicinity of the infrared light band is used as shown in FIG. 8A, a light source that emits light in the infrared light band is preferable used as a light source for the optical sensor. This makes it possible to set the signal light band to a band with respect to which the optical sensor has high sensitivity. FIG. 8B is a graph showing exemplary wavelength characteristics of light emitted from an infrared LED used in the present embodiment.

The detection light filter preferably transmits the light from the light source for the optical sensor, and cuts off light having the other wavelengths. FIG. 8C is a graph showing exemplary filter characteristics of an infrared light transmission filter used in the present embodiment. The filter having the filter characteristics shown in FIG. 8C is used, for example, in the case where the light source for the optical sensor emits infrared light.

### Infrared LED

Next, the configuration of the backlight 10 including the infrared LED 12 is explained in detail. As described above, the infrared light transmission filter 18 is provided in the path of light incident on the optical sensor (see, for example, FIG. 7). Therefore, for the infrared LED 12, an LED that emits infrared light in a wavelength range that passes through the infrared light transmitting filters 18 is used. For example, for the infrared LED 12, an LED that emits infrared light with a shorter wavelength than the fundamental absorption edge wavelength of silicon (about 1100 nm) is used. By using such an infrared LED, when the pixel circuit and the optical sensor are formed of polysilicon, infrared light emitted from the infrared LED 12 can be detected by the optical sensor.

Alternatively, for the infrared LED, an LED that emits infrared light having a peak wavelength in the atmospheric absorption spectrum may be used. More preferably, an LED that emits infrared light having a peak wavelength in a range of 860 nm to 960 nm is used. FIG. 8D shows a general sunlight spectrum. The atmospheric absorption spectrum refers to a spectrum where sunlight is attenuated by the atmosphere, and specifically refers to a wavelength range of from 780 nm to 820 nm with an attenuation peak of 800 nm, a wavelength range of from 860 nm to 960 nm with an attenuation peak of 920 nm, etc. In such wavelength ranges, sunlight is attenuated by scattering attenuation by air having nitrogen and oxygen molecules as the main components and aerosol, absorption by water vapor, or absorption by ozone, oxygen molecules, and carbon dioxide.

Sunlight is attenuated while passing through the atmosphere due to the above-described atmospheric absorption, and thus is weaker on the ground than outer space. In particular, infrared light in a wavelength range of from 860 nm to 960 nm is absorbed by water vapor in the atmosphere and thus is significantly attenuated. When the infrared LED 12 that emits infrared light in this wavelength range, which is an attenuated part of sunlight, is used, a band-pass filter whose pass band includes the wavelength range of infrared light may be provided in the path of light incident on the optical sensor, whereby the influence of sunlight exerted on a scanned image is reduced, which enables to detect a touch position with high accuracy

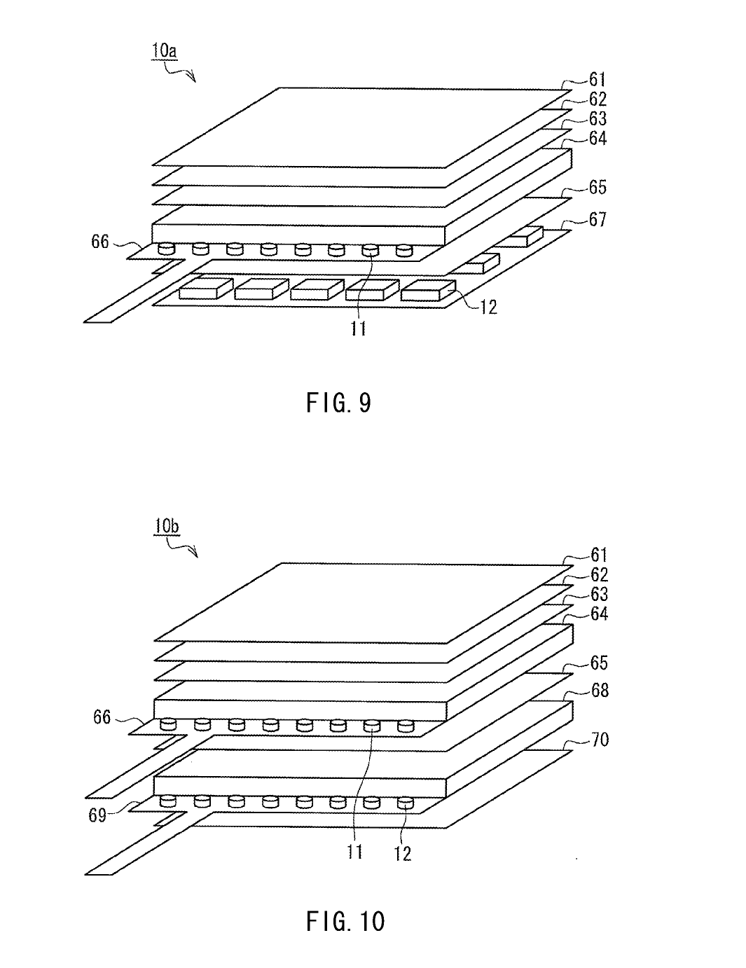

FIGS. 9 to 13 show first to fifth exemplary configurations of the backlight 10, respectively. In backlights 10a to 10e shown in FIGS. 9 to 13, two lens sheets 61 and 62 and a diffusion sheet 63 are provided on one surface of a light guide plate 64 or 74, and a reflection sheet 65 or 72 is provided on the other surface thereof.

In the backlights 10a and 10b shown in FIGS. 9 and 10, a flexible printed circuit board 66 having white LEDs 11 arranged thereon one-dimensionally is provided on a side surface of the light guide plate 64, and an infrared light source is provided on a reflection sheet 65 side surface of the light guide plate 64. In the backlight 10a, a circuit substrate 67 having, as an infrared light source, infrared LEDs 12 arranged thereon two-dimensionally is provided. In the backlight 10b, an infrared light source includes a light guide plate 68, a flexible printed circuit board 69 having infrared LEDs 12 arranged thereon one-dimensionally (which is provided at a side surface of the light guide plate 68), and a reflection sheet 70. For the reflection sheet 65, a sheet that allows infrared light to pass therethrough and reflects visible light (e.g., a reflection sheet formed of a polyester-based resin) can be used. For the reflection sheet 70, a sheet that reflects infrared light can be used. By thus adding the infrared light source to the backlight that emits visible light, a backlight 10 that emits both visible light and infrared light can be configured using, for example, a conventional visible-light backlight as it is.

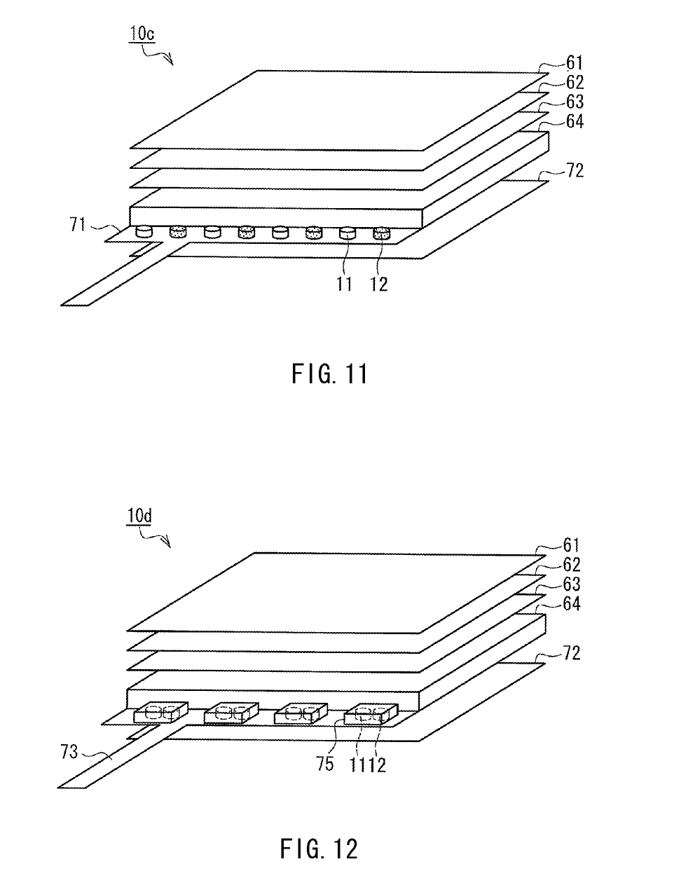

In the backlight 10c shown in FIG. 11, a flexible printed circuit board 71 having white LEDs 11 and infrared LEDs 12 alternately arranged thereon one-dimensionally is provided at a side surface of the light guide plate 64. For the reflection sheet 72, a sheet that reflects both visible light and infrared light can be used. By thus arranging a mixture of the white LEDs 11 and the infrared LEDs 12 along a side surface of the light guide plate 64, a backlight 10 can be configured that has the same structure as a conventional backlight having white LEDs alone and that emits both visible light and infrared light.

In the backlight 10d shown in FIG. 12, resin packages 75, each of which encloses therein a white LED 11 and an infrared LED 12 together, are arranged on a flexible printed circuit board 73 one-dimensionally. This flexible printed circuit board 73 is provided at a side surface of the light guide plate 64. By thus enclosing a white LED 11 and an infrared LED 12 in one resin package 75, a plurality of LED light emitters can be arranged efficiently in a narrow space. It should be noted that in one resin package 75, one white LED 11 and one infrared LED 12 may be enclosed, or a plurality of white LEDs 11 and a plurality of infrared LEDs 12 may be enclosed.

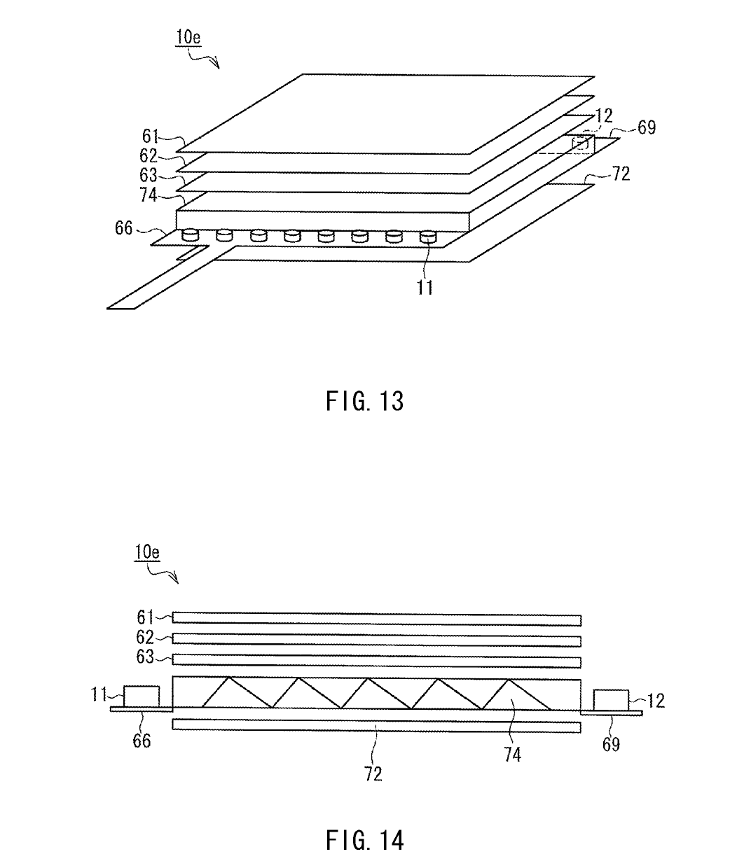

In the backlight 10e shown in FIG. 13, a flexible printed circuit board 66 having white LEDs 11 arranged thereon one-dimensionally is provided at one side surface of the light guide plate 74. In this backlight 10e, a flexible printed circuit board 69 having infrared LEDs 12 arranged thereon one-dimensionally is provided at an opposing side surface of the light guide plate 74. FIG. 14 is a cross-sectional view of the backlight 10e. The light guide plate 74 has a configuration that allows white light entering from one side surface and infrared light entering from the opposing side surface to propagate therethrough. By thus separately arranging the white LEDs 11 and the infrared LEDs 12 along two opposing side surfaces of the light guide plate 74, a backlight member such as a light guide plate can be used commonly for the two types of LEDs.

### Embodiment 2

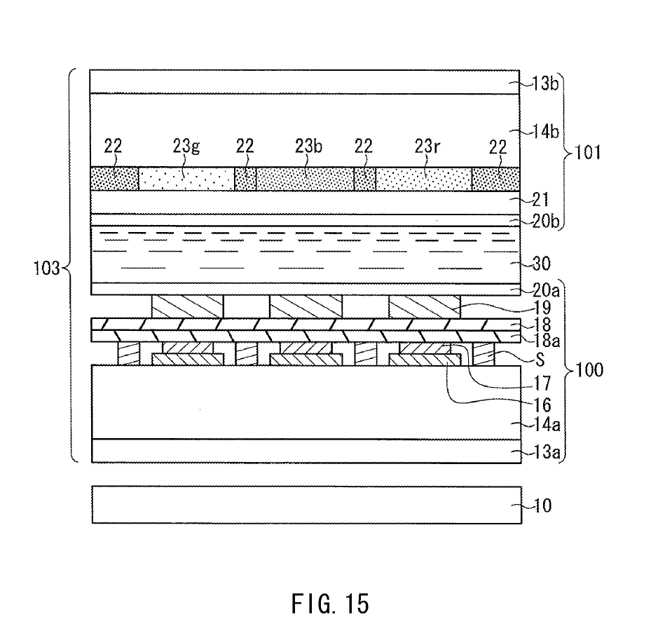

FIG. 15 is a cross-sectional view of a liquid crystal display device according to Embodiment 2. The liquid crystal display device shown in FIG. 15 has a configuration obtained by adding an unwanted infrared light cut filter 18a to the configuration shown in FIG. 1, the cut filter 18a being provided so as to overlap the infrared light transmission filter 18. The unwanted infrared light cut filter 18a is a filter that cuts off light in a band that is unnecessary for the optical sensor, among light in the transmission band of the infrared light transmission filter 18. The unwanted infrared light cut filter 18a is formed with a filter in which a light absorbing material that absorbs infrared rays in a band unnecessary for the optical sensor is used. More specifically, the unwanted infrared light cut filter 18a contains, for example, an infrared light absorbing composition containing phosphoric acid ester. By laminating the unwanted infrared light cut filter 18a over the infrared light transmission filter 18, light in a wavelength band outside the wavelength band set for the optical sensor, i.e., light that becomes noise, is removed further, whereby the S/N ratio can be improved.

In the configuration shown in FIG. 15, the unwanted infrared light cut filter 18a is provided below the infrared light transmission filter 18, but the order of lamination may be reversed. Further, the order of steps of laminating the infrared light transmission filter 18 and the unwanted infrared light cut filter 18a may be reversed. Still further, a plurality of unwanted infrared light cut filters may be laminated further thereon.

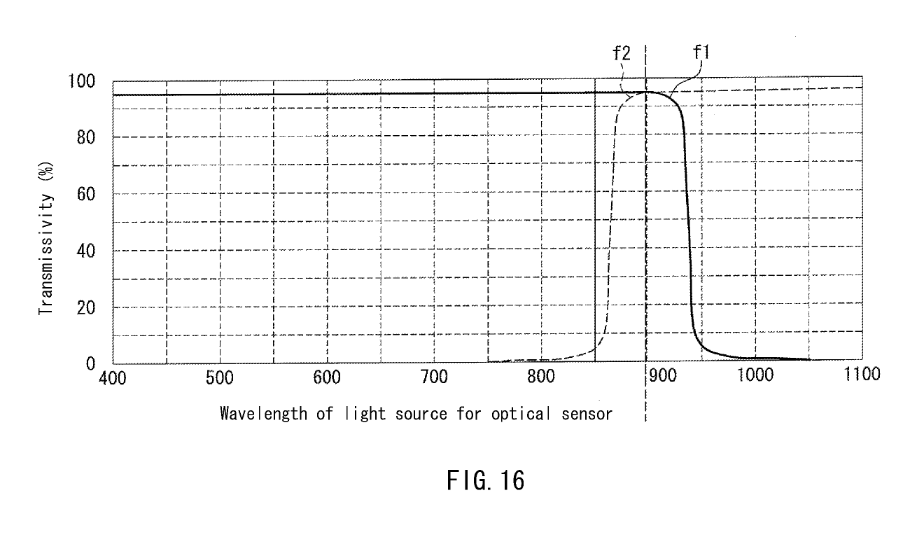

FIG. 16 is a graph showing exemplary transmission characteristics of the infrared light transmission filter 18 and the unwanted infrared cut filter 18a. In FIG. 16, a dotted line f2 shows characteristics of the infrared light transmission filter 18, and a solid line f1 shows characteristics of the unwanted infrared light cut filter 18a, in the example shown in FIG. 16. For example, in the case where the light source for the optical sensor is a light source (e.g., infrared LED) that emits infrared light having a peak wavelength in a range of 860 nm to 960 nm, it is preferable to use the combination of the infrared light transmission filter 18 and the unwanted infrared light cut filter 18a having the characteristics as shown in the graph of FIG. 16.

Thus, a detection light filter can be formed with a combination of a filter that functions as a high-pass filter and a filter that functions as a low-pass filter, whereby a filter can be configured that transmits light in a wavelength range in which wavelengths of the light source for the optical sensor are included, while cutting off light of wavelengths in a range outside the aforementioned range.

### Embodiment 3

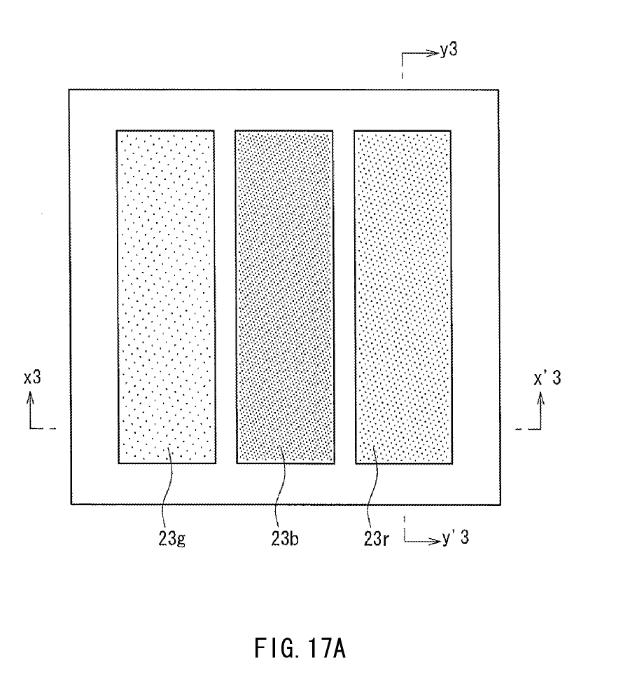

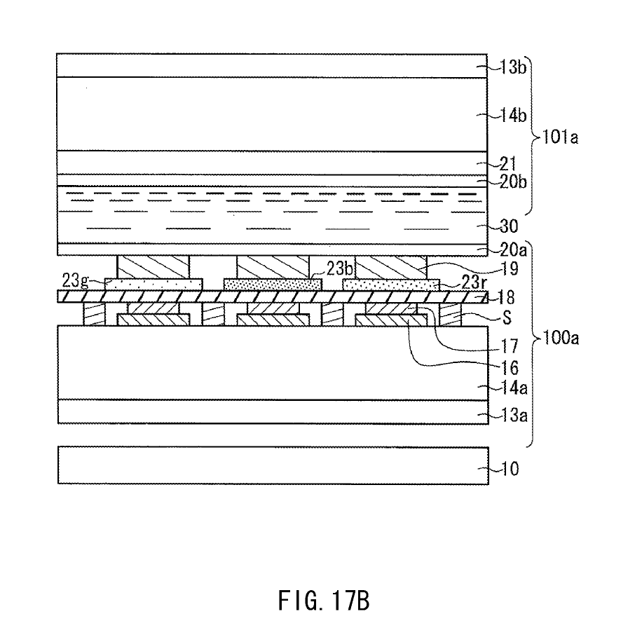

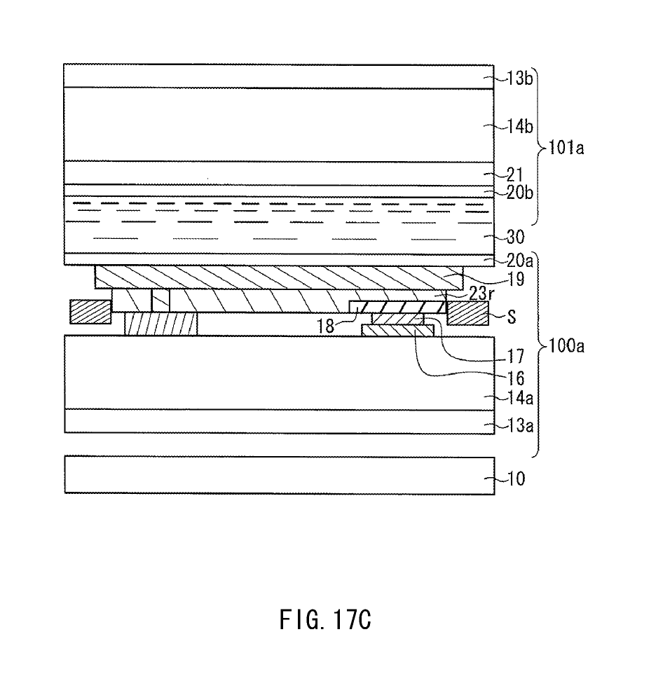

FIG. 17A is a top view showing an area for one pixel in a pixel region 1 of a liquid crystal display device according to Embodiment 3. FIG. 17B is a cross-sectional view taken along a line x3-x′3 in FIG. 17A. FIG. 17C is a cross-sectional view taken along a line y3-y′3 in FIG. 17A. The color filter is provided in a TFT substrate 101a in the present embodiment, while, in Embodiment 1, the color filter is provided in the counter substrate 101. As shown in FIGS. 17A to 17C, in the TFT substrate 100a, an optical sensor is formed with a light shielding layer 16 provided on the glass substrate 14a, and a photodiode 17 provided on the light shielding layer 16. On the glass substrate 14a, TFTs, M1s, gate lines G, and source lines S that compose pixel circuits are formed also. In the TFT substrate 100a, further, an infrared light transmission filter 18 is provided so as to cover the photodiodes 17. On this infrared light transmission filter 18, green color filters 23g, blue color filters 23b, and red color filters 23r are provided. The color filters 23g, 23b, and 23r are formed at positions corresponding to the color dots 23g, 23b, and 23r, respectively. On the color filters 23g, 23b, and 23r, pixel electrodes 19 are provided, respectively.

According to the present embodiment, the color filters are provided in the TFT substrate 100a side. Therefore, a black matrix is not needed, or a smaller black matrix may be provided. As a result, the aperture ratio is improved.

Further, in the present embodiment also, like in Embodiments 1 and 2, the infrared light transmission filter 18 is formed immediately above the optical sensor. Therefore, external light incident through pixel openings is prevented from causing internal reflection and becoming a noise component for the optical sensors. Besides, the above-described configuration makes it possible to eliminate unnecessary spaces between the infrared light transmission filter 18 and the optical sensors. Therefore, light that becomes a noise component for the optical sensors, such as internal reflection light, can be reduced, whereby the S/N ratio can be improved.

In the case where the color filters 23g, 23b, and 23r, as well as the infrared light transmission filter 18 are provided in the counter substrate, the infrared light transmission filter 18 partially occupies the pixel openings. In contrast, in the present embodiment, the above-described configuration makes openings for the infrared light transmission filter 18 unnecessary. As a result, the pixel aperture ratio (transmissivity of the liquid crystal panel) is improved. Further, the above-described configuration makes openings for optical sensors unnecessary, too. Therefore, light leaking through openings is reduced, whereby the contrast of the liquid crystal panel can be improved.

Further, the above-described configuration makes it possible to eliminate errors in positioning the color filters, which tend to occur in the step of laminating the counter substrate 101a and the TFT substrate 100a. As a result, a problem of incidence of light, such as external light, that becomes a noise component, which occurs due to displacement of the infrared light transmission filter 18 from the position immediately above the optical sensor, is eliminated, whereby the S/N ratio is improved.

The infrared light transmission filter 18 and the color filters 23g, 23b, and 23r are all formed with negative-type photosensitive resists each of which is obtained by dispersing a pigment or carbon in a base resin. As to the fabrication process, both of the infrared light transmission filter 18 and the color filters 23g, 23b, and 23r are formed in the process for forming the TFT substrate 100a. Therefore, the TFT substrate 100a can be fabricated efficiently.

In the above-described embodiments, the photodetecting element is not limited to the photodiode, but may be, for example, a phototransistor or the like.

The present invention is industrially applicable as a display device having sensor circuits in a pixel region on a TFT substrate.

1. A liquid crystal display device comprising:
a first substrate on which a pixel circuit is provided;
a second substrate arranged so as to face the first substrate with a liquid crystal layer being interposed therebetween;
a photodetecting element provided on the first substrate; and
a detection light filter that is provided between the photodetecting element and the liquid crystal layer and that cuts off light in a band outside a signal light band that is a band of light to be detected by the photodetecting element.

2. The liquid crystal display device according to claim 1, further comprising:
a backlight provided on a side of the first substrate opposite to the liquid crystal layer, the backlight including a light emitter that emits light in the signal light band; and
a shielding part that is provided between the photodetecting element and the backlight and that prevents light of the backlight from directly reaching the photodetecting element.

3. The liquid crystal display device according to claim 1, further comprising:
a backlight that is provided on a side of the first substrate opposite to the liquid crystal layer, and that includes:
a light emitter that emits light in the signal light band; and
another light emitter that emits light that is in a band different from the signal light band and that is used for display; and
a shielding part that is provided between the photodetecting element and the backlight and that prevents light of the backlight from directly reaching the photodetecting element.

4. The liquid crystal display device according to claim 1, wherein a color filter is provided on the first substrate.

5. The liquid crystal display device according to claim 1, wherein the signal light band falls in a band of infrared rays.

6. A method for manufacturing a liquid crystal display device, the method comprising the steps of:
forming a pixel circuit and a photodetecting element on a first substrate;
forming a detection light filter on the first substrate so that the detection light filter covers the photodetecting element, the detection light filter cutting off light in a band outside a signal light band that is a band of light to be detected by the photodetecting element; and
laminating the first substrate on which the detection light filter is formed and a second substrate so that the first substrate and the second substrate face each other, and injecting liquid crystal into between the first substrate and the second substrate.

7. The method for manufacturing a liquid crystal display device according to claim 6, wherein in the step of forming the detection light filter on the first substrate, a color filter is also formed on the first substrate.
